(19) United States
(12) Patent Application Publication
(10) Pub. No.: US 2024/0129839 A1
(43) Pub. Date: Apr. 18, 2024

(54) RADIO NETWORK NODE, NETWORK NODE AND METHODS PERFORMED THEREIN

(71) Applicant: Telefonaktiebolaget LM Ericsson (publ), Stockholm (SE)

(72) Inventors: Gunnar Mildh, Sollentuna (SE); Haseeb Akhtar, Garland, TX (US)

(21) Appl. No.: 18/278,520

(22) PCT Filed: Mar. 8, 2021
(86) PCT No.: PCT/EP2021/055784

§ 371 Date: Aug. 23, 2023

(51) Int. Cl. H04W 48/16; H04W 16/18; H04W 60/04

(52) U.S. Cl. CPC H04W 48/16; H04W 16/18; H04W 60/04; H04W 84/042

(57) ABSTRACT

Embodiments herein relate to for example a method performed by a radio network node for handling data in a wireless communication network. The radio network node transmits to a network node a report associated with a user equipment, UE, wherein the report comprises an identifier uniquely identifying the UE across all operators sharing the wireless communication network.

### TECHNICAL FIELD

Embodiments herein relate to a network node, a radio network node and methods performed therein for communication. Furthermore, a computer program product and a computer readable storage medium are also provided herein. In particular, embodiments herein relate to handle data e.g. relating to network planning, within a wireless communication network.

### BACKGROUND

In a typical wireless communication network, User equipments (UE), also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a radio network node such as a radio access node e.g., a Wi-Fi access point or a radio base station (RBS), which in some networks may also be denoted, for example, a NodeB, an eNodeB″, or a gNodeB. A service area or cell area is a geographical area where radio coverage is provided by the radio network node. The radio network node communicates over an air interface operating on radio frequencies with the UE within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify upcoming releases of a Fifth Generation (5G) network also known as new radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

The 5G system (5GS) defined by 3GPP Rel-15 introduces both a new radio access network (NG-RAN) and a new core network denoted as 5GC.

Similar to E-UTRAN, the NG-RAN uses a flat architecture and consists of base stations, called gNBs, which are interconnected with each other by means of the Xn-interface. The gNBs are also connected by means of the NG interface to the 5GC, more specifically to the Access and Mobility Function (AMF) by the NG-C interface and to the User Plane Function (UPF) by means of the NG-U interface. The gNB in turn supports one or more cells which provides the radio access to the UE. The radio access technology (called next radio, NR) is orthogonal frequency division multiplex (OFDM) based like in LTE and offers high data transfer speeds and low latency.

It is expected that NR will be rolled out gradually on top of the legacy LTE network starting in areas where high data traffic is expected. This means that NR coverage will be limited in the beginning and users must move between NR and LTE as they go in out of coverage. To support fast mobility between NR and LTE and avoid change of core network, LTE eNBs will also connect to the 5G-CN and support the Xn interface. An eNB connected to 5GC is called a next generation eNB (ng-eNB) and is considered part of the NG-RAN (see FIG. 1). LTE and ng-eNBs are described for completeness and will not be considered further in this document.

The logical architecture of the gNB may be split into a Central Unit (CU) and Distributed Unit (DU) which are connected through the F1 interface. The CU/DU split enables a centralized deployment (which in turn simplifies e.g. coordination between cells) without putting extreme demands on the front-haul transmission bandwidth and latency. The internal structure of the gNB is not visible to the core network and other RAN nodes, so the gNB-CU and connected gNB-DUs are only visible to other gNBs and the 5GC as a gNB.

Several different CU-DU split options were considered in 3GPP in the initial phase of the Rel-15 standardization. The NR protocol stack, which includes Physical (PHY) layer, medium access control (MAC) layer, radio link control (RLC) layer, Packet Data Convergence Protocol (PDCP) layer, and radio resource control (RRC) layer, was taken as a basis for this investigation and different split points across the protocol stack was investigated. After careful analysis, 3GPP agreed on a higher layer split where PDCP/RRC reside in the CU and RLC/MAC/PHY reside in the DU. This is shown in FIG. 2

During normal operation of RAN, the default dimensioning, planning and configuration will ensure that key performance indicator (KPI) targets are fulfilled most of the time. However, irrespective of how thorough the dimensioning, planning and configuration process is, there might be occasions and areas where the default dimensioning, planning and configuration will not be able to fulfill the target KPIs.

One example of such a situation is that congestion occurs temporarily in a certain area. During periods of congestion there are not enough RAN resources to fulfill KPI targets according to the default configuration.

Another example is that the default configuration of handover functionality leads to unwanted handover ping-pong for fast moving UEs in a certain area.

To address these scenarios the O-RAN standardization organization defines RAN Intelligent Controllers (RIC) responsible for optimizing the network performance. At least the following RICs are defined:
Non-Real Time RIC residing in the Service Management and Orchestration (SMO) framework, responsible for long-term optimization of the radio network and end user performance.
Near-Real Time RIC located closer to the radio functions such as the gNB-CU-control plane (CP), gNB-CU-user plane (UP) and gNB-DU defined in 3GPP. This RIC is responsible for optimizing the radio network and end user performance in near real time e.g. on a 10 ms-1000 ms basis.

The O-RAN architecture is shown in FIG. 3.

Additionally, these RICs will host applications deployed on the RIC platform that may implement optimization, analytics functions etc. These are called rApps for the Non-RT RIC and xApps for the Near-RT RIC.

It is deemed desirable for the RICs and the rApps/xApps to be able to observe the performance for individual wireless devices in order to be able to optimize network behavior to improve the end user performance. In order to this it is required to correlate measurement reports and other reported events that are collected in the RICs that are stemming from the same wireless device (in 3GPP called UE) even in cases these reports are collected from different network nodes such as the gNB-CU-CP, gNB-CU-UP, DU etc.

Similarly, it is desirable that the actions that the RICs and the rApps/xApps triggers are wireless device specific. The actions could include wireless devices specific polices, or commands. Since these actions are triggered by the RICs and the rApps/xApps but may be executed in the network nodes such as the gNB-CU-CP, gNB-CU-UP, DU etc. it is required that the wireless device is identified in the action (e.g. signaling message from the RIC to the network functions).

Example of a RIC function that optimizes the wireless device mobility:
1. Data is collected on how different wireless device moves in the network.
2. The data is sent to the RIC (either Near-Realtime RIC or Non-Realtime RIC).
3. The RIC has an intelligent function that detects and predicts future mobility patterns based on the data.
4. If the RIC predicts that it is likely that based on historic mobility patterns a certain wireless device is soon to be handed over to another cell, it can send a message to the gNB-CU-CP handling that wireless device warning the gNB-CU-CP about the impending mobility, making it possible for the gNB-CU-CP to initiate handover preparation faster than it would other be able to do, thus reducing the risk for handover failure causing end users traffic disturbance.

In order to do step 3 above it is required that the RIC is able to separate events and measurements for the different wireless devices to detect and make accurate predictions of mobility patterns. To separate the events, the reports need to be associated with identifiers of the wireless devices that the RIC can use to uniquely identify the wireless devices.

In order to do step 4 the RIC needs to have up to date measurement reports and other events for a specific wireless device to predict that handover will happen soon. Also, here it is required that the RIC can uniquely identify the wireless devices. Similarly it is required that the network nodes (in this case gNB-CU-CP) knows which wireless device the RIC is referring to so the message needs to include a wireless device identifier enabling the gNB-CU-CP to uniquely identify the wireless device.

For the reasons above the O-RAN standardization group has discussed the usage of the following identifiers that should be reported by the different network functions enabling the RICs and rApps/xApps to trigger wireless device specific actions and correlate events from the same device.

gNB should use:
AMF UE NGAP ID
GUAMI

These identifiers are defined in 3GPP 38.413 and transferred over 3GPP NG-C or N2 interface.

Additionally, if the gNB is separated into a separate gNB-CU-CP (called O-CU-CP in O-RAN), gNB-CU-UP (called O-CU-UP in O-RAN) and gNB-DU (called O-DU in O-RAN) the gNB-CU-CP should use:
AMF UE NGAP ID
GUAMI
gNB-CU UE F1AP ID
gNB-CU-CP UE E1AP ID
RAN UE ID (optional)

The gNB-CU-UP should use:
gNB-CU-CP UE E1AP ID
RAN UE ID (optional)

The identifiers above is used on the E1 interface in 3GPP specifications and are defined to be unique within one gNB.

The gNB-DU should use:
gNB-CU-CP UE F1AP ID
RAN UE ID (optional)

The identifiers above is used on the F1 interface in 3GPP specifications and are defined to be unique within one gNB.

By sending measurement or other event reports using the identifiers above on the O-RAN interfaces O1 and E2 it is possible for the RICs and xApps/rApps to correlate the reports from different nodes that they are associated with the same wireless device.

### SUMMARY

The solutions outlined in the background section does not support network sharing scenarios. The reason for this is that in network sharing scenarios the gNB-DU part can be shared by multiple operators while the gNB-CU (gNB-CU-CP and gNB-CU-UP) part could be dedicated to each operator. In 3GPP terminology this would be part of Multi-Operator RAN (MORAN) sharing. In such scenario the gNB-DU could be connected to multiple gNB-CU-CPs. In this case there is a risk that the gNB-CU-CP UE F1AP ID and/or RAN UE ID allocated by one gNB-CU-CP is reused by another gNB-CU-CP that is connected to the same gNB-DU. In this case it could happen that reports associated with one wireless device is confused by reports associated with another wireless device in the RIC or xApps/rApps. If this happens any correlation of data or actions taken based on this data for this wireless device will be erroneous.

An object of embodiments herein is to provide a mechanism for improving handling data for, for example, network planning of the wireless communication network in an efficient manner.

According to an aspect the object may be achieved by a method performed by a radio network node for handling data in a wireless communication network. The radio network node transmits to a network node a report associated with a UE, wherein the report comprises an identifier uniquely identifying the UE across all operators sharing the wireless communication network.

According to another aspect the object may be achieved by a method performed by a network node for handling network planning in a wireless communication network. The network node receives a report from a radio network node, wherein the report is associated with a UE and comprises an identifier uniquely identifying the UE across all operators sharing the wireless communication network.

According to yet another aspect the object may be achieved by providing a radio network node and a network node configured to perform the methods herein.

It is furthermore provided herein a computer program product comprising instructions, which, when executed on at least one processor, cause the at least one processor to carry out any of the methods above, as performed by the network node or the radio network node, respectively. It is additionally provided herein a computer-readable storage medium, having stored thereon a computer program product comprising instructions which, when executed on at least one processor, cause the at least one processor to carry out the method according to any of the methods above, as performed by the network node or the radio network node, respectively.

Embodiments herein introduce a mechanism to support unique handling of UE identifiers even in case of network sharing. It does this by ensuring that UE related reports sent from the radio network nodes (e.g. DU, and others) to centralized data collection entities such as the RICs are unique to that UE across all operators sharing the networks, enabling the RICs and xApps/rApps to correlate the data associated with the UEs.

Embodiments herein make it possible to correlate UEs information such as measurement reports or other events in the network node such as RICs and rApps/xApps. This will also make it possible to send wireless device specific polices or commands to the network nodes such as the gNB-CU-CP, gNB-CU-UP and gNB-DU. The solution makes this possible by ensuring the uniqueness of the wireless identifier also in scenarios of network sharing where the same gNB-DU is served by multiple gNB-CU-CP associated with different mobile operators. Embodiments herein thus enable the network node to correlate data from UEs in an efficient manner leading to an improved way of performing network planning in the wireless communication network.

### BRIEF DESCRIPTION OF THE DRAWINGS

Embodiments will now be described in more detail in relation to the enclosed drawings, in which:

FIG. 1 shows an NG-RAN architecture according to prior art;

FIG. 2 shows a block diagram depicting an gNB according to prior art;

FIG. 3 shows a O-RAN architecture according to prior art;

FIG. 4 shows a wireless communication network according to embodiments herein;

FIG. 5 shows a combined signalling scheme and flow chart according to embodiments herein;

FIG. 6 shows a flow chart depicting a method performed by a radio network node according to embodiments herein;

FIG. 7 shows a flow chart depicting a method performed by a network node according to embodiments herein;

FIG. 8 shows a schematic overview depicting an example of embodiments herein;

FIG. 9 shows a schematic overview of message flows in a wireless communication network according to embodiments herein;

FIG. 10 shows a schematic overview of message flows in a wireless communication network according to embodiments herein;

FIG. 11 shows a block diagram depicting radio network nodes according to embodiments herein;

FIG. 12 shows a block diagram depicting network nodes according to embodiments herein;

FIG. 13 schematically illustrates a telecommunication network connected via an intermediate network to a host computer;

FIG. 14 is a generalized block diagram of a host computer communicating via a base station with a user equipment over a partially wireless connection; and

FIGS. 15-18 are flowcharts illustrating methods implemented in a communication system including a host computer, a base station and a user equipment.

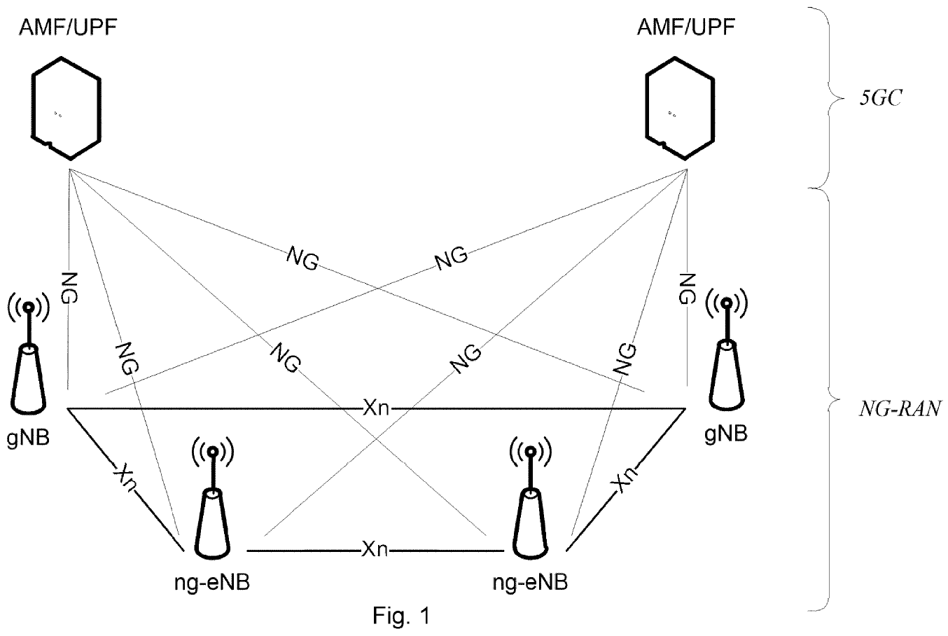

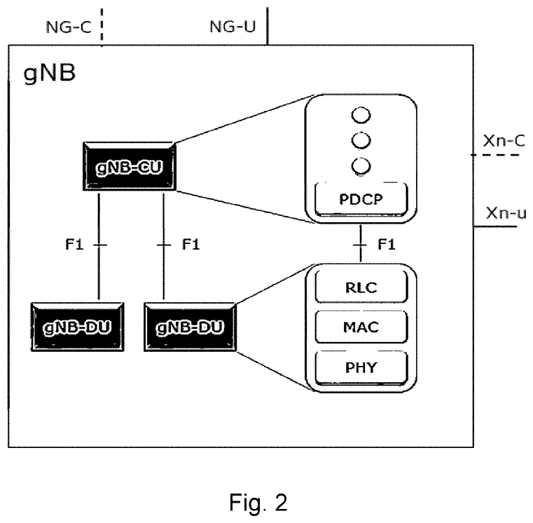

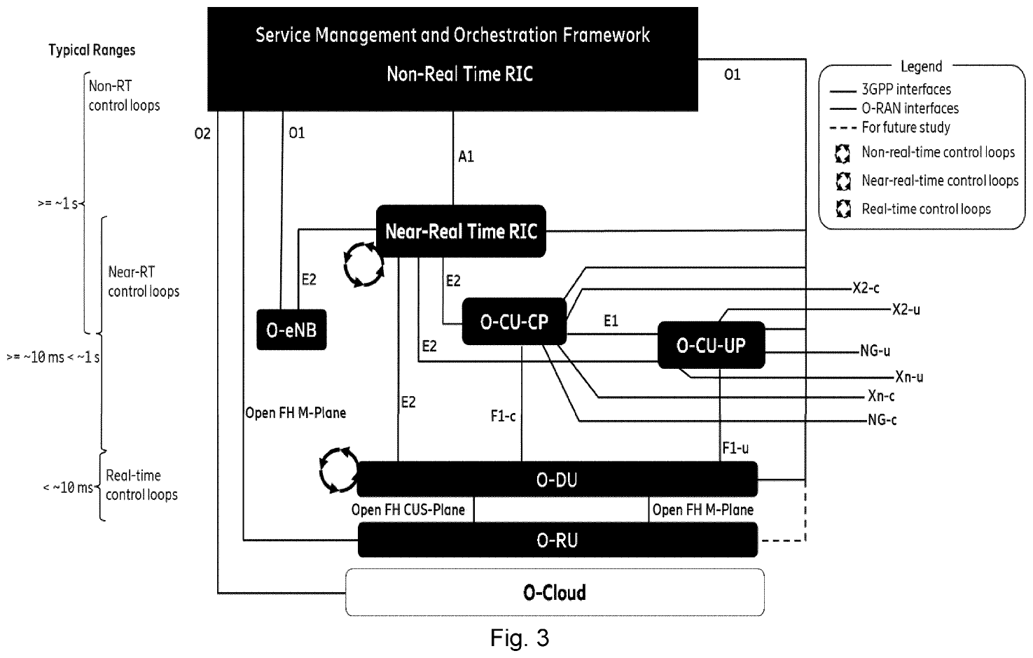

### DETAILED DESCRIPTION

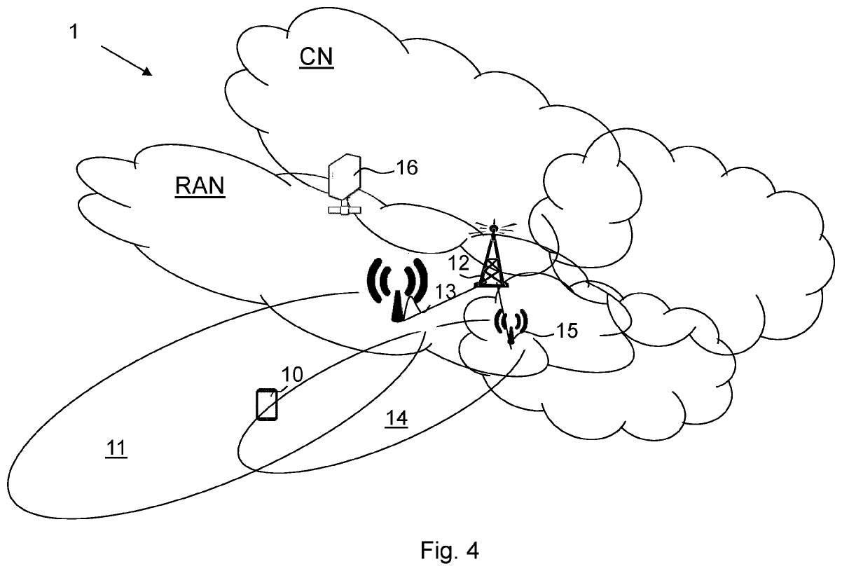

Embodiments herein relate to communication networks in general. FIG. 4 is a schematic overview depicting a wireless communication network 1. The wireless communication network 1 comprises one or more RANs e.g. a first RAN (RANI), connected to one or more CNs. The wireless communication network 1 may use one or a number of different RA technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g. 3G and LTE.

In the wireless communication network 1, UEs, e.g. a UE 10, such as a mobile station, a non-access point (non-AP) STA, a STA, a wireless device and/or a wireless terminal, are connected via the one or more RANs, to the one or more CNs. It should be understood by those skilled in the art that “UE” is a non-limiting term which means any terminal, wireless communication terminal, user equipment, Machine Type Communication (MTC) device, Internet of Things operable device, Device to Device (D2D) terminal, mobile device e.g. smart phone, laptop, mobile phone, sensor, relay, mobile tablets or any device communicating within a cell or service area.

The wireless communication network 1 comprises a (central) radio network node 12 providing radio coverage over a geographical area, a first service area or a first cell 11, of a first radio access technology (RAT), such as New Radio (NR), LTE, UMTS, Wi-Fi or similar. The first cell may be provided by a distributed unit 13 such as a first transmission and reception point (TRP). The radio network node 12 may be a radio access network node such as radio network controller or an access point such as a wireless local area network (WLAN) access point or an Access Point Station (AP STA), an access controller, a base station, e.g. a radio base station such as a NodeB, an evolved Node B (eNB, eNodeB), a gNodeB, a base transceiver station, Access Point Base Station, base station router, a transmission arrangement of a radio base station, a stand-alone access point or any other network unit capable of serving a UE within the first service area served by the radio network node 12 depending e.g. on the first radio access technology and terminology used. The radio network node 12 may be referred to as central unit, source radio network node serving a source cell or similar.

The radio network node 12 or an additional radio network node may further provide radio coverage over a geographical area, a second service area or a second cell 14, of a second radio access technology (RAT), such as New Radio (NR), LTE, UMTS, Wi-Fi or similar. The second cell may be provided by a second distributed unit such as a transmission and reception point (TRP). The first cell 11 may be referred to as a source cell 11 or similar and the second cell 14 may be referred to as secondary cell 14. The radio network node 12 may be a distributed node comprising a central unit and distributed units. The cells may be provided by one and same radio network node or provided from separated radio network nodes.

The wireless communication network further comprises a network node 16 such as a centralized data collection entity such as a RIC or network node comprising an rApp or xApp.

Embodiments herein a radio network node such as the distributed unit 13 in a network sharing scenario where it is served by multiple radio network nodes such as gNB-CUs, sends a unique UE identifier to the network node 16 such as a data collection entity e.g. RIC or SMO, or rApp/xApp, where the identifier includes information about the PLMN or Cell or CU etc. that the UE is associated with. Additionally or alternatively, the radio network node 12 such as a gNB-CU (or gNB-CU-CP) can be configured with a range of identifiers to use thus ensuring the uniqueness of the identifier in case of network sharing scenarios.

The network node 16 such as the RIC or rApp/xApp may perform correlation and trigger actions based on the data associated with the same UE 10.

Multiple solutions for ensuring the uniqueness of the ID are herein proposed:

Solution 1:

The radio network node includes an additional identifier (A) with the reports already including the existing gNB-CU-CP UE F1AP ID and/or the RAN UE ID. This additional identifier (A) can be associated with each operator thus making the combination of the additional identifier (A), and the gNB-CU-CP UE F1AP ID and/or the RAN UE ID unique within the reporting radio network node and network. The additional identifier (A) may be:
a Public Land Mobile Network ID (PLMN ID) or it could be an index to the PLMN ID list that is broadcasted in the radio cell by the gNB-DU,
an identifier of the gNB-CU-CP that the UE is currently served by, since it is the gNB-CU-CP that allocates the gNB-CU-CP UE F1AP ID and/or the RAN UE ID the combination of the gNB-CU-CP identifier and these other identifiers would be unique for the radio network node and network.
an identifier of the Cell or RAN area or Tracking Area which could be different for the different operator sharing the network.
a integer value, which is configured to be different for different operator
any other parameter which could be different for different operators.

Solution 2:

The configuration of the radio network node 12, e.g. the gNB-CU-CP to support the possibility to configure different ranges of gNB-CU-CP UE F1AP ID and/or the RAN UE ID to be used. In this way the different radio network nodes such as gNB-CU-CPs for the different operators can be configured with different non-overlapping ranges of identifiers for gNB-CU-CP UE F1AP ID and/or the RAN UE ID. In this way there is no risk that the gNB-DU would be allocated the same gNB-CU-CP UE F1AP ID and/or the RAN UE ID for two different UEs, ensuring that the reports send from the gNB-DU that include the gNB-CU-CP UE F1AP ID and/or the RAN UE ID will be uniquely associated with one UE.

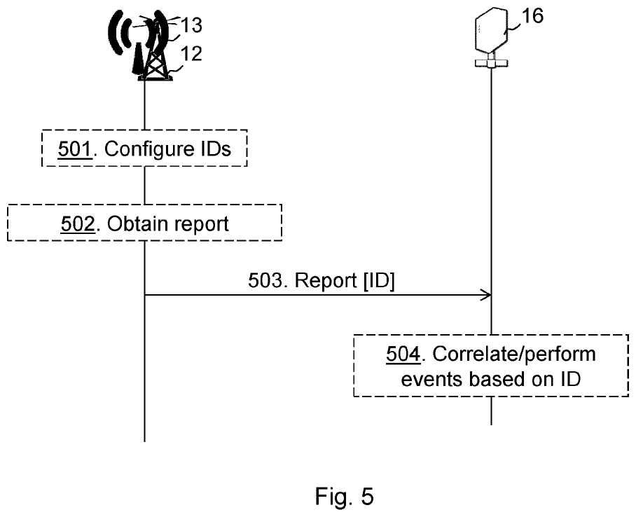

FIG. 5 shows a combined flowchart and signalling scheme according to embodiments herein.

Action 501. The radio network node such as the radio network node or the distributed unit 12 may be configured with a range of identifiers to use thus ensuring the uniqueness of the identifier in case of network sharing scenarios.

Action 502. The radio network node may obtain the report of the UE 10.

Action 503. The radio network node transmits the report to the network node 16. The report is associated with the UE and comprises an identifier uniquely identifying the UE across all operators sharing the wireless communication network.

Action 504. The network node 16 may then correlate and/or trigger actions based on the data associated with the same UE 10 from the report.

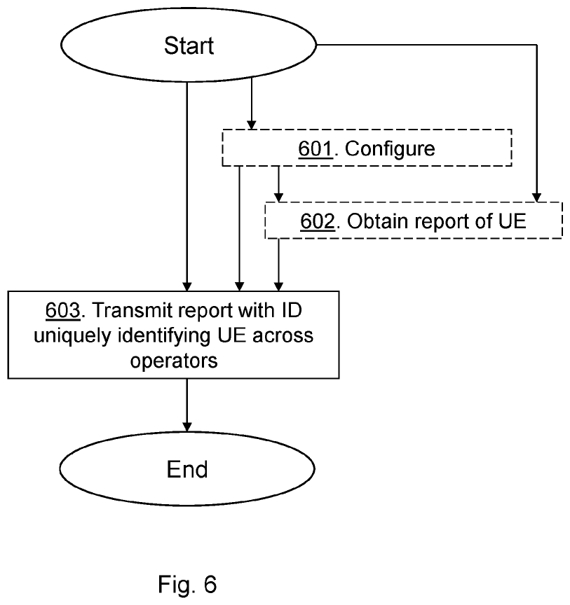

The method actions performed by the radio network node such as the distributed unit 13 for handling network planning of the wireless communications network according to embodiments will now be described with reference to a flowchart depicted in FIG. 6. The actions do not have to be taken in the order stated below, but may be taken in any suitable order. Actions performed in some embodiments are marked with dashed boxes.

Action 601. The radio network node such as the radio network node or the distributed unit 12 may be configured with a range of identifiers to use thus ensuring the uniqueness of the identifier in case of network sharing scenarios.

Action 602. The radio network node may obtain the report of the UE 10.

Action 603. The radio network node transmits the report to the network node 16. The report is associated with the UE and comprises the identifier uniquely identifying the UE across all operators sharing the wireless communication network.

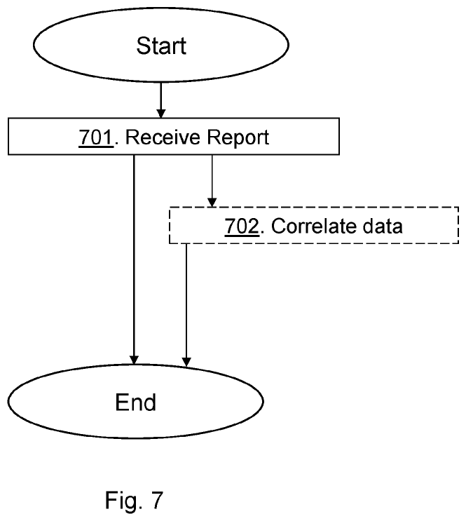

The method actions performed by the network node such as a RIC or xApp/rApp for handling network planning in the wireless communications network according to embodiments will now be described with reference to a flowchart depicted in FIG. 7. The actions do not have to be taken in the order stated below, but may be taken in any suitable order. Actions performed in some embodiments are marked with dashed boxes.

Action 701. The network node 16 receives the report from the radio network node. The report is associated with the UE 10 and comprises the identifier uniquely identifying the UE across all operators sharing the wireless communication network.

Action 702. The network node 16 may then correlate and/or trigger actions based on the data associated with the same UE 10 from the report.

When the radio network node 12 such as a gNB-CU-CP (or gNB-CU) establishes a wireless device specific context (UE context) in the distributed unit 13 such as a gNB-DU it will send a message (UE CONTEXT SETUP REQUEST) to the gNB-DU over the F1-C interface defined in 3GPP. The message is an F1-AP message and is defined in 3GPP 38.473. Parts of the message is copied below:

UE CONTEXT SETUP REQUEST

This message is sent by the gNB-CU to request the setup of a UE context.

Direction: gNB-CU→gNB-DU.

The message contains among other things the following information elements:

| IE/Group Name | Presence |
|---|---|
| gNB-CU UE F1AP ID | Mandatory |
| New gNB-CU UE F1AP ID | Optional |
| RAN UE ID | Optional |

As can be seen the message always include the gNB-CU UE F1AP ID (mandatory) and could also include a New gNB-CU UE F1AP ID or RAN UE ID.

These information elements may be allocated by the gNB-CU-CP and are unique within the gNB-CU-CP (and the whole gNB).

If the gNB-DU then sends a report for the UE 10 using these identifiers above the network node such as RICs or rApps/xApps can correlate this report with other reports e.g. obtained from the gNB-CU-CP that also use these identifiers.

This does however not work in case the gNB-DU is connected to multiple gNB-CUs (or gNB-CU-CPs) since the different gNB-CU could allocate the same values of these identifiers.

To address the following solutions are proposed:

Solution 1:

The gNB-DU includes an additional identifier (A) with the reports already including the existing gNB-CU-CP UE F1AP ID and/or the RAN UE ID. This additional identifier (A) can be associated with each operator thus making the combination of A and gNB-CU-CP UE F1AP ID and/or the RAN UE ID unique within the reporting node and network. Identifier (A) could be
a Public Land Mobile Network ID (PLMN ID) or it could be an index to the PLMN ID list that is broadcasted in the radio cell by the gNB-DU. The PLMN is possible to use since the UE CONTEXT SETUP REQUEST will in case of network sharing include the current PLMN ID of the serving PLMN of the wireless device.
an identifier of the gNB-CU-CP that the device is currently served by, since it is the gNB-CU-CP that allocates the gNB-CU-CP UE F1AP ID and/or the RAN UE ID the combination of the gNB-CU-CP identifier and these other identifiers would be unique for the node and network. A possible identifier for the gNB-CU-CP identifier is to use the gNB-CU Name which is provided to the gNB-DU during F1 connection setup (as part of the F1 Setup Response message defined in 38.473).
an identifier of the Cell or RAN area or Tracking Area which could be different for the different operator sharing the network. These identifier is possible to use since they are exchanged over F1 signaling e.g. the NR Cell Global ID.
a integer value, which is configured to be different for different operator. This could be configured via the OAM interface towards the DU.
any other parameter which could be different for different operators.

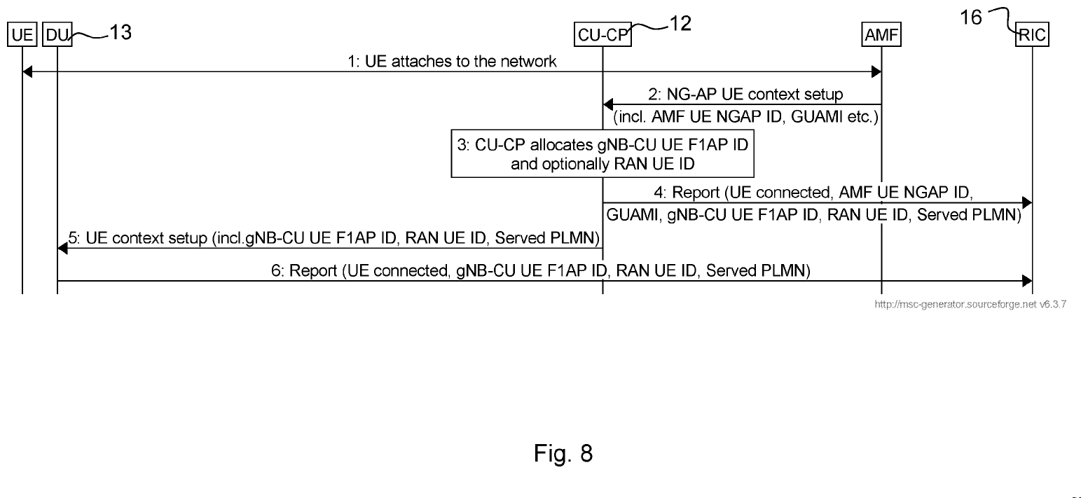

Below in FIG. 8 is an example signaling flow where solution 1 is used. It should be noted that solution 1 can also be supported in other flows and in different orders etc.

In the signalling flow example the UE (wireless device) is attaching to the core network (AMF) in action 1. The AMF then setup the UE context in the RAN, this message will include the AMF UE NGAP ID and GUAMI as well as other information, action 2. In action 3 the CU-CP allocates the gNB-CU UE F1AP ID and optionally a RAN UE ID for this UE. In action 4 the CU-CP sends a report that the UE has connected to the RAN and this report could include identifiers shown in the chart. In case the CU-CP only serves one PLMN it may not be needed to include the PLMN in the report. In action 5 the CU-CP sets up the UE context in the DU by sending a context setup message including the identifiers shown in the signalling flow. In action 6 the DU reports that the UE has connected to the DU, this report includes the gNB-CU UE F1AP ID and optionally the RAN UE ID. Additionally the report includes the unique identifier ensuring the uniqueness of the UE identity. In the signalling flow this identifier is the serving PLMN, it could however be other identifiers as discussed above.

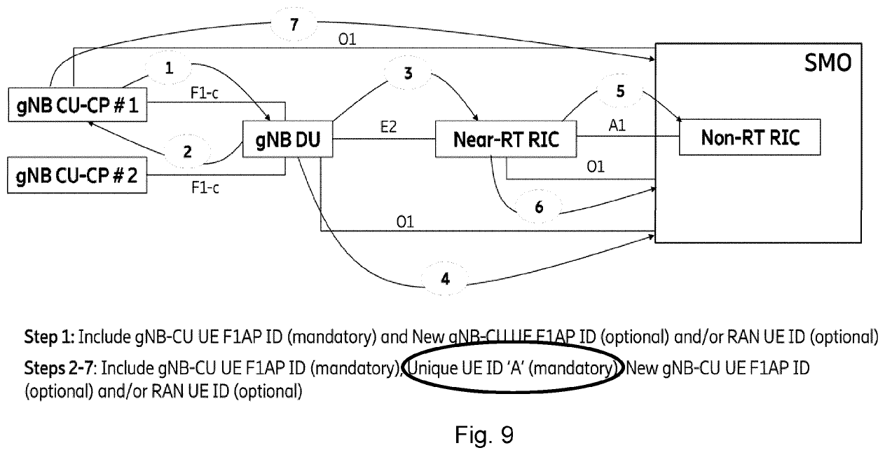

FIG. 9 shows message flows wherein the step 1 the message includes gNB-CU UE F1AP ID (mandatory), a new gNB-CU UE F1AP ID (optional), and/or RAN UE ID (optional). Step 2-7 messages include gNB-CU UE F1AP ID (mandatory), a unique UE ID ‘A’ (mandatory), a new gNB-CU UE F1AP ID (optional), and/or RAN UE ID (optional)

Solution 2

The configuration of the network node, e.g. the gNB-CU-CP support the possibility to configure different ranges of gNB-CU-CP UE F1AP ID and/or the RAN UE ID to be used. In this way the different gNB-CU-CPs for the different operators can be configured with different non-overlapping ranges of identifiers for gNB-CU-CP UE F1AP ID and/or the RAN UE ID. In this way there is no risk that the gNB-DU would be allocated the same gNB-CU-CP UE F1AP ID and/or the RAN UE ID for two different wireless devices, ensuring that the reports send from the gNB-DU that include the gNB-CU-CP UE F1AP ID and/or the RAN UE ID will be uniquely associated with one wireless device.

In order to support this solution the gNB-CU-CP need to be capable to be configured with the range of identifiers to use.

In the figure section additional example how the identifiers are used over the O-RAN interfaces are shown.

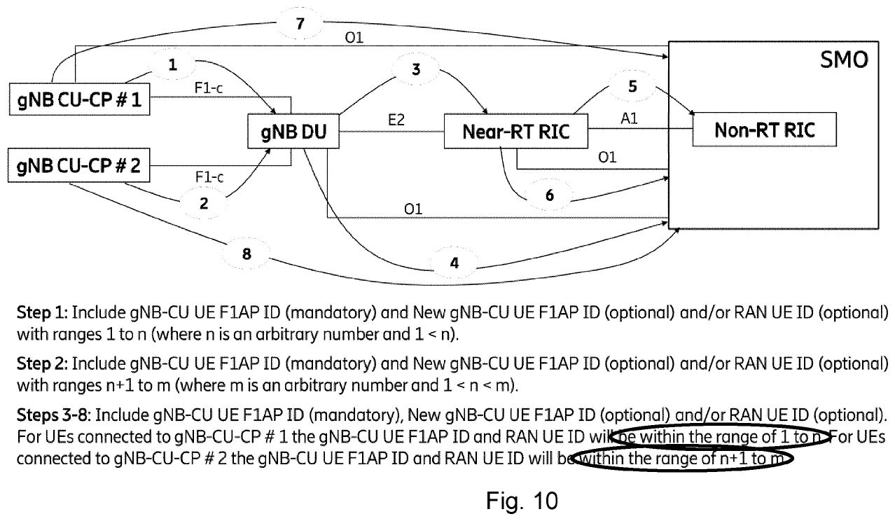

FIG. 10 shows message flows wherein the step 1 the message includes gNB-CU UE F1AP ID (mandatory), a new gNB-CU UE F1AP ID (optional), and/or RAN UE ID (optional) with ranges 1 to n (where n is an arbitrary number and 1<n).

Step 2 the message includes gNB-CU UE F1AP ID (mandatory), a new gNB-CU UE F1AP ID (optional), and/or RAN UE ID (optional) with ranges n+1 to m (where m is an arbitrary number and 1<n<m).

Step 3-8 the message includes gNB-CU UE F1AP ID (mandatory), a new gNB-CU UE F1AP ID (optional), and/or RAN UE ID (optional). For UEs connected to gNB-CU-CP #1 the gNB-CU UE F1AP ID and RAN UE ID will be within the range of 1 to n.). For UEs connected to gNB-CU-CP #2 the gNB-CU UE F1AP ID and RAN UE ID will be within the range of n+1 to m.

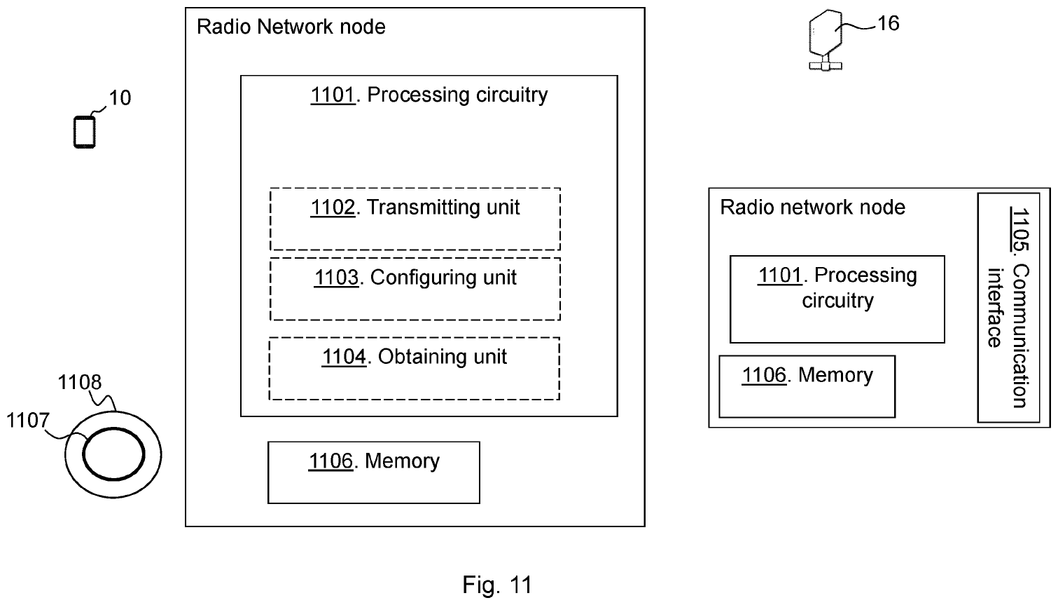

FIG. 11 is a block diagram depicting the radio network node for handling data in the wireless communication network 1 according to embodiments herein.

The radio network node may comprise processing circuitry 1101, e.g. one or more processors, configured to perform the methods herein.

The radio network node may comprise a transmitting unit 1102, e.g. a transmitter or transceiver. The radio network node, the processing circuitry 1101, and/or the transmitting unit 1102 is configured to transmit to the network node 16, the report. The report is associated with the UE 10 and comprises the identifier uniquely identifying the UE across all operators sharing the wireless communication network.

The radio network node may comprise a configuring unit 1103. The radio network node, the processing circuitry 1101, and/or the configuring unit 1103 may be configured to configure the radio network node with a range of IDs associated with a certain central unit and/or operator.

The radio network node may comprise an obtaining unit 1104, e.g. a receiver or transceiver. The radio network node, the processing circuitry 1101, and/or the obtaining unit 1104 may be configured to obtain one or more report related to the UE 10.

The radio network node further comprises a memory 1106. The memory comprises one or more units to be used to store data on, such as IDs, reports, additional IDs, applications to perform the methods disclosed herein when being executed, and similar. The radio network node may comprise a communication interface 1105 comprising e.g. a receiver, a transmitter, a transceiver and/or one or more antennas. Thus, it is herein provided the radio network node for handling data in the wireless communication network, wherein the radio network node comprises processing circuitry and the memory, said memory comprising instructions executable by said processing circuitry whereby said radio network node is operative to perform any of the methods herein.

The methods according to the embodiments described herein for the radio network node are respectively implemented by means of e.g. a computer program product 1107 or a computer program, comprising instructions, i.e., software code portions, which, when executed on at least one processor, cause the at least one processor to carry out the actions described herein, as performed by the radio network node. The computer program product 1107 may be stored on a computer-readable storage medium 1108, e.g. a disc, a universal serial bus (USB) stick or similar. The computer-readable storage medium 1108, having stored thereon the computer program product, may comprise the instructions which, when executed on at least one processor, cause the at least one processor to carry out the actions described herein, as performed by the radio network node. In some embodiments, the computer-readable storage medium may be a transitory or a non-transitory computer-readable storage medium.

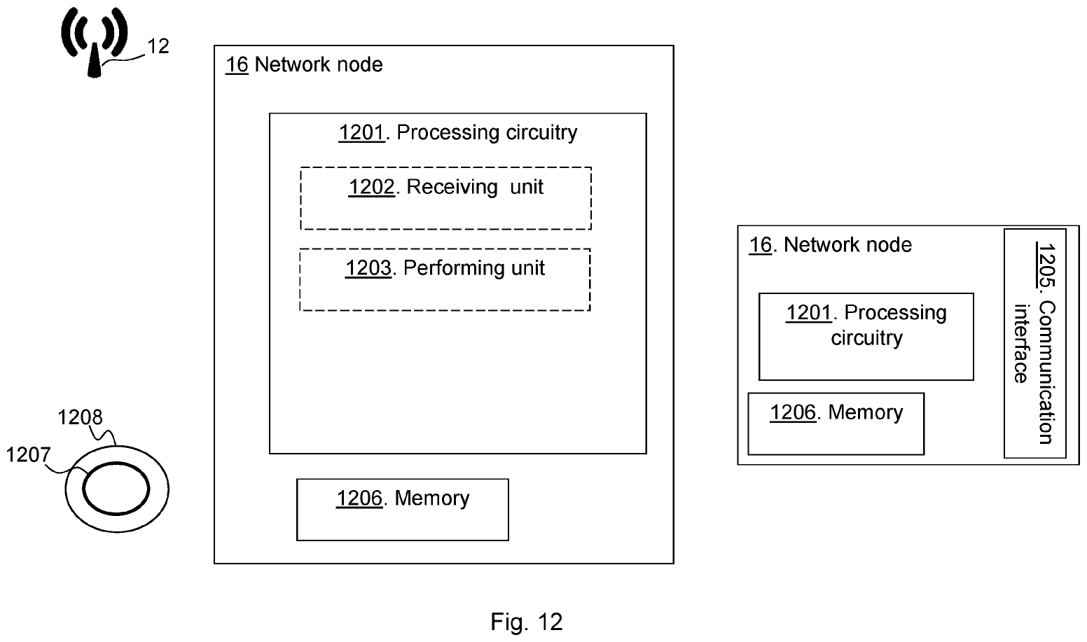

FIG. 12 is a block diagram depicting the network node for handling data relating to network planning in the wireless communication network according to embodiments herein.

The network node 16 may comprise processing circuitry 1201, such as one or more processors, configured to perform methods herein.

The network node 16 may comprise a receiving unit 1202, e.g. a receiver or transceiver. The network node 16, the processing circuitry 1201, and/or the receiving unit 1202 is configured to receive from the radio network node, the report. The report is associated with the UE 10 and comprises the identifier uniquely identifying the UE across all operators sharing the wireless communication network.

The network node 16 may comprise a performing unit 1203. The network node 16, the processing circuitry 1201, and/or the performing unit 1203 may be configured to perform correlation of different reports associated with a same UE and/or trigger actions based on the data associated with the same UE 10 from the reports.

The network node 16 further comprises a memory 1206. The memory comprises one or more units to be used to store data on, such as reports, data, IDs, additional IDs, ranged of IDs, applications to perform the methods disclosed herein when being executed, and similar. The network node 16 may comprise a communication interface 1205 comprising e.g. a receiver, a transmitter, a transceiver, and/or one or more antennas. Thus, it is herein provided the network node 16 for handling communication of the UE in the wireless communication network, wherein the network node 16 comprises processing circuitry and the memory, said memory comprising instructions executable by said processing circuitry whereby said network node 16 is operative to perform any of the methods herein.

The methods according to the embodiments described herein for the network node 16 are respectively implemented by means of e.g. a computer program product 1207 or a computer program, comprising instructions, i.e., software code portions, which, when executed on at least one processor, cause the at least one processor to carry out the actions described herein, as performed by the network node 16. The computer program product 1207 may be stored on a computer-readable storage medium 1208, e.g. a disc, a universal serial bus (USB) stick or similar. The computer-readable storage medium 1208, having stored thereon the computer program product, may comprise the instructions which, when executed on at least one processor, cause the at least one processor to carry out the actions described herein, as performed by the network node 16. In some embodiments, the computer-readable storage medium may be a transitory or a non-transitory computer-readable storage medium.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

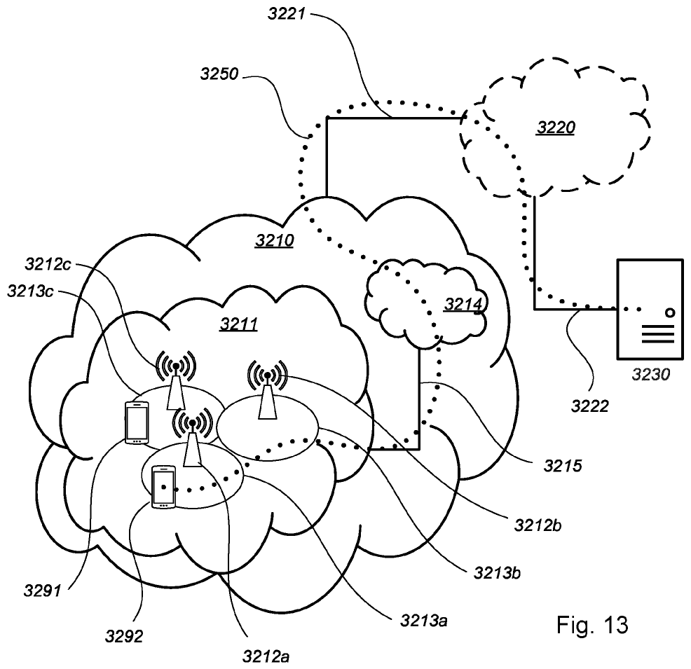

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

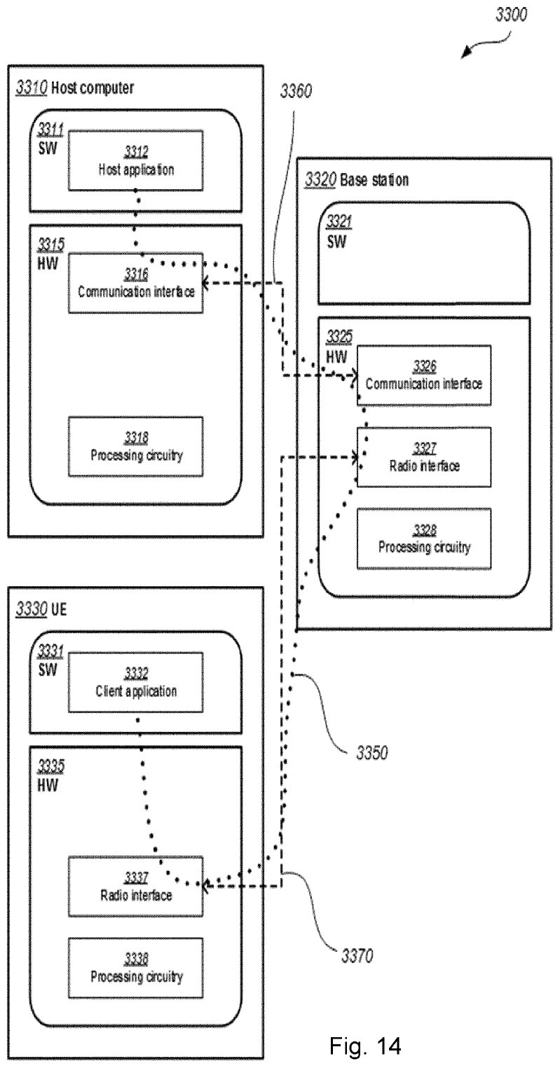

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may achieve an efficient network planning as uniquely identifying reports of UEs and thereby provide benefits such as improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

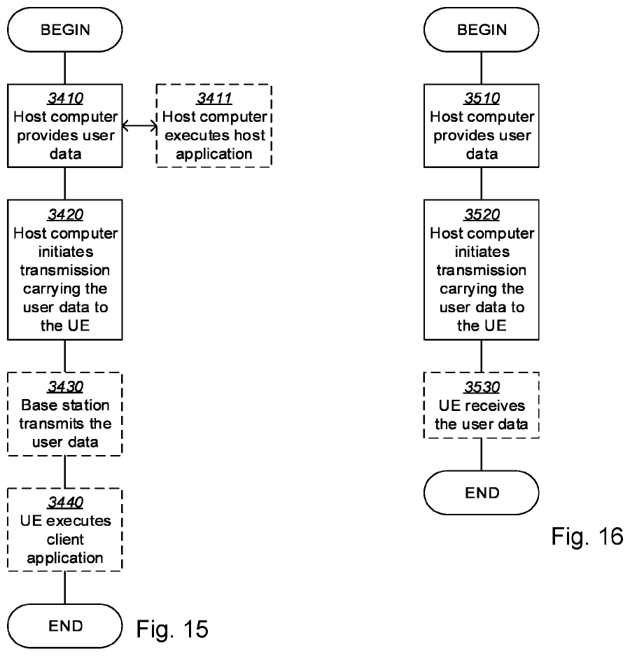

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

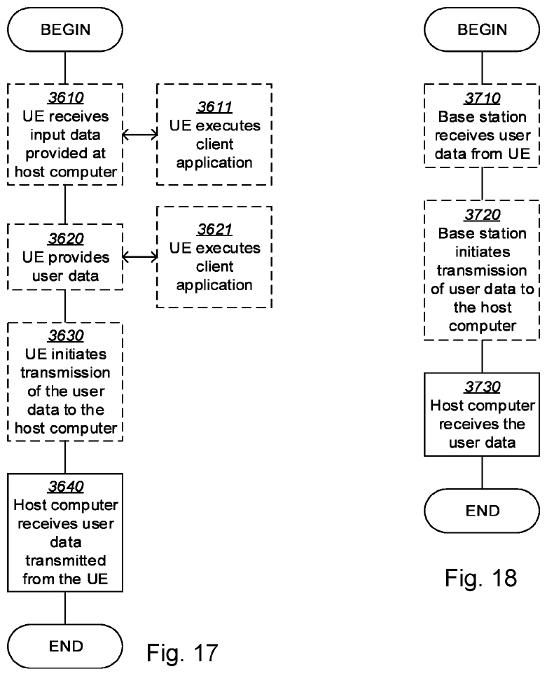

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviation

3GPP 3^{rd} Generation Partnership Project
4G 4^{th} Generation
5G 5^{th} Generation
5GC 5G Core
5GS 5G System
AMF Access and Mobility management Function
CN Core Network
CU Central Unit
DAPS Dual Active Protocol Stack
DL Downlink
DRB Data Radio Bearer
DU Distributed Unit
eNB Evolved Node B (A radio base station in LTE.)
E-UTRAN Evolved Universal Terrestrial Radio Access Network
gNB 5G Node B (A radio base station in NR.)
HFN Hyper Frame Number
HO Handover
LTE Long Term Evolution
MAC Medium Access Control
MAC CE MAC Control Element
Msg Message
NG The interface/reference point between the RAN and the CN in 5G/NR.
NG-C The control plane part of NG (between a gNB and an AMF).
NG-RAN Next Generation Radio Access Network
NG-U The user plane part of NG (between a gNB and a UPF).
NR New Radio
OFDM Orthogonal Frequency Division Multiplex
PCI Physical Cell Identity
PDCP Packet Data Convergence Protocol
PHY Physical (Layer)
PUSCH Physical Uplink Shared Channel
RAN Radio Access Network
RLC Radio Link Control
ROHC RObust Header Compression
RRC Radio Resource Control
SN Sequence Number
SRB Signalling Radio Bearer
TS Technical Specification
TX Transmit/Transmission/Transmitter
UE User Equipment
UL Uplink
UPF User Plane Function
URLLC Ultra-Reliable Low-Latency Communication
Xn The interface/reference point between two gNBs.
XnAP Xn Application Protocol

1. A method performed by a radio network node for handling data in a wireless communication network, the method comprising:
transmitting to a network node a report associated with a user equipment, UE, wherein the report comprises an identifier uniquely identifying the UE across all operators sharing the wireless communication network.

2. The method according to claim 1, wherein the identifier comprises one or more of the following: a Public Land Mobile Network, PLMN, ID; an index to a PLMN ID list that is broadcasted in the radio cell by the radio network node; an identifier of the radio network node that the UE is currently served by; an identifier of the Cell or Radio Access Network, RAN, area or Tracking Area; a integer value, which is configured to be different for different operator; and any other parameter which could be different for different operators.

3. The method according to claim 1, further comprising configuring radio network node with a range of identifiers to use to ensure the uniqueness of the identifier in case of network sharing scenarios.

4. The method according to claim 1, further comprising obtaining the report of the UE.

5. A method performed by a radio network node for handling network planning in a wireless communication network, the method comprising:
receiving from a radio network node a report associated with a user equipment, UE, wherein the report comprises an identifier uniquely identifying the UE across all operators sharing the wireless communication network.

6. The method according to claim 5, wherein the identifier comprises one or more of the following: a Public Land Mobile Network, PLMN, ID; an index to a PLMN ID list that is broadcasted in the radio cell by the radio network node; an identifier of the radio network node that the UE is currently served by; an identifier of the Cell or Radio Access Network, RAN, area or Tracking Area; a integer value, which is configured to be different for different operator; and any other parameter which could be different for different operators.

7. The method according to claim 5, further comprising performing a correlation of reports and/or events based on the identifier.

8. A radio network node for handling data in a wireless communication network, wherein the radio network node is configured to:
transmit to a network node a report associated with a user equipment, UE, wherein the report comprises an identifier uniquely identifying the UE across all operators sharing the wireless communication network.

9. A network node for handling network planning in a wireless communication network, wherein the network node is configured to:
receive from a radio network node a report associated with a user equipment, UE, wherein the report comprises an identifier uniquely identifying the UE across all operators sharing the wireless communication network.

10. (canceled)

11. (canceled)
